(19) United States
(12) Patent Application Publication
(10) Pub. No.: US 2024/0224335 A1
(43) Pub. Date: Jul. 4, 2024

(54) SYSTEMS AND METHODS FOR EARLY INDICATION FOR MULTIPLE FEATURES

(71) Applicant: Telefonaktiebolaget LM Ericsson (publ), Stockholm (SE)

(72) Inventors: Luca Feltrin, Solna (SE); Mattias Bergström, Sollentuna (SE); Andreas Höglund, Solna (SE); Oscar Ohlsson, Bromma (SE)

(21) Appl. No.: 18/289,143

(22) PCT Filed: May 9, 2022
(86) PCT No.: PCT/SE2022/050446

§ 371 Date: Nov. 1, 2023

Related U.S. Application Data
(60) Provisional application No. 63/186,583, filed on May 10, 2021.

(51) Int. Cl. H04W 74/0833; H04W 76/20; H04W 84/06

(52) U.S. Cl. CPC H04W 74/0833; H04W 76/20; H04W 84/06

(57) ABSTRACT

Systems and methods for early indication for multiple features are provided. In some embodiments, a method performed by a wireless device for early indication of features includes: determining to use an on-demand Random Access (RA) resource; transmitting, to a network node, an activation preamble to activate the on-demand RA resource; and transmitting, to the network node, a preamble on the on-demand RA resource. Certain embodiments may provide one or more of the following technical advantages. The amount of RA resources can be made larger when there is demand for it. If no User Equipment (UE) is interested in using the on-demand RA resource, those radio resources can be used by the network for other purposes, e.g., dynamic scheduling of user data on Physical Uplink Shared Channel (PUSCH). The amount of RA resources hence scales with the demand without tying up and wasting resources when not used.

### RELATED APPLICATIONS

This application claims the benefit of provisional patent application Ser. No. 63/186,583, filed May 10, 2021, the disclosure of which is hereby incorporated herein by reference in its entirety.

### TECHNICAL FIELD

The present disclosure relates generally to early indication of features.

### BACKGROUND

The 4-step Random Access (RA) type has been used in Fourth Generation (4G) Long Term Evolution (LTE) and is also the baseline for Fifth Generation (5G) New Radio (NR). The principle of this procedure in NR is shown in FIG. 1. FIG. 1 illustrates a 4-step Random Access Channel (RACH) procedure.

### Step 1: Preamble Transmission:

The UE randomly selects a RA preamble (PREAMBLE_INDEX) corresponding to a selected Synchronization Signal (SS)/Physical Broadcast Channel (PBCH) block, transmit the preamble on the Physical RACH (PRACH) occasion mapped by the selected SS/PBCH block. When the gNB detects the preamble, it estimates the Timing Advance (TA) the UE should use in order to obtain Uplink (UL) synchronization at the gNB.

### Step 2: RA Response (RAR):

The gNB sends a RAR including the TA, the Temporary Cell (TC)-Radio Network Temporary Identifier (RNTI) to be used by the User Equipment (UE), a Random Access Preamble identifier that matches the transmitted PREAMBLE_INDEX and a grant for Msg3. The UE expects the RAR and thus, monitors a Physical Downlink Control Channel (PDCCH) addressed to RA-RNTI to receive the RAR message from the gNB until the configured RAR window (ra-ResponseWindow) has expired or until the RAR has been successfully received.

From 3rd Generation Partnership Project (3GPP) TS 38.321: “The MAC entity may stop ra-ResponseWindow (and hence monitoring for Random Access Response(s)) after successful reception of a Random Access Response containing Random Access Preamble identifiers that matches the transmitted PREAMBLE_INDEX.”

### Step 3: “Msg3” (UE ID or UE-Specific Cell-RNTI (C-RNTI)):

In Msg3 the UE transmits an identifier (the initial part of the 5G-Temporary Mobile Subscriber Identity (TMSI) for initial access, if it is in Radio Resource Control (RRC)_INACTIVE a UE-specific Inactive-RNTI (I-RNTI) or the C-RNTI for RRC_CONNECTED). If the gNB cannot decode Msg3 at the granted UL resources, it may send a Downlink Control Information (DCI) addressed to (T)C-RNTI for retransmission of Msg3. Hybrid Automatic Repeat Request (HARQ) retransmission is requested until the UEs restart the random access procedure from step 1 after reaching the maximum number of HARQ retransmissions or until Msg3 can be successfully received by the gNB.

### Step 4: “Msg4” (Contention Resolution):

In Msg4, the gNB responds with the contention resolution ID (CR-ID) which matches the part of Msg3 containing the UE identifier, i.e., only one UE will declare the contention resolved in case several UEs used the same preamble (and the same grant for Msg3 transmission) simultaneously.

For Msg4 reception, the UE monitors Temporary Cell RNTI (TC-RNTI) (if it transmitted its UE ID in Msg3) or C-RNTI (if it transmitted its C-RNTI in Msg3).

### 2-Step RA Type

The 2-step RA type gives much shorter latency than the ordinary 4-step RA. In the 2-step RA, the preamble and a message corresponding to Msg3 (e.g., Physical Uplink Shared Channel (PUSCH)) in the 4-step RA can, depending on configuration, be transmitted in two subsequent slots. The msgA PUSCH is sent on a resource dedicated to the specific preamble. The 2-step RA procedure is depicted in FIG. 2.

Upon successful reception of msgA, the gNB will respond with a msgB. The msgB may be either a “successRAR”, “fallbackRAR or “Back off”. The content of msgB has been agreed as seen below. It is noted in particular that fallbackRAR provides a grant for a Msg3 PUSCH that identifies resources in which the UE should transmit the PUSCH, as well as other information.

Note: The notations “msgA” and “MsgA” are used interchangeably herein to denote message A. Similarly, the notations “msgB” and “MsgB” are used interchangeably herein to denote message B.

The possibility to replace the 4-step message exchange by a 2-step message exchange would lead to reduced RA latency. On the other hand, the 2-step RA will consume more resources since it uses contention-based transmission of the data. This means that the resources that are configured for the data transmission may often be unused. Another difference is that 2-step RA operates without a Timing Advance (TA) since there is no feedback from the gNB on how to adjust the uplink synchronization before the data payload is transmitted in MsgA PUSCH. TA is effectively zero for 2-step RA; therefore, the solution is restricted to use in cell of smaller size, whereas 4-step RA can operate in any cell size.

If both the 4-step and 2-step RA are configured in a cell on shared PRACH resources (and for the UE), the UE will choose its preamble from one specific set if the condition of 4-step RA is met and from another set if the condition of 2-step RA (based on the measured RSRP) is met. Hence a preamble partitioning is done to distinguish between 4-step and 2-step RA when shared PRACH resources are used. Alternatively, the PRACH configurations are different for the 2-step and 4-step RA procedure, in which case it can be deduced from where the preamble transmission is done if the UE is doing a 2-step or 4-step procedure.

When the 4-step RA is applied for Small Data Transmission (SDT), the Msg3 will contain the RRCResumeRequest message and UP data. The gNB will, as in the legacy case, respond with the contention resolution ID (CR-ID) to resolve contention, and at this point, the TC-RNTI will be used by the UE as C-RNTI, i.e., the UE will monitor PDCCH for DCI scrambled by C-RNTI to obtain new UL grants in case subsequent transmissions are needed. The SDT procedure ends when the gNB sends a RRCRelease with suspend config message, thereby keeping the UE in Inactive state. Alternatively, the gNB may instead send a RRCResume and move the UE to connected state.

When the 2-step RA is applied for SDT, the MsgA will contain the RRCResumeRequest message and UP data. The gNB will, as in the legacy case, respond with the contention resolution ID (CR-ID) to resolve contention. It will also send a C-RNTI and the UE will monitor the PDCCH for DCI scrambled by C-RNTI to obtain new UL grants in case subsequent transmissions are needed. As for the 4-step procedure, the SDT procedure ends when the gNB sends a RRCRelease with suspend config message and thereby keeping the UE in Inactive state. Alternatively, the gNB may instead send a RRCResume and move the UE to connected state.

There currently exist certain challenges. In 3GPP, Msg1 indication can be used to indicate the use of a certain feature, either through preamble partitioning or from the use of separately configured RACH Occasions (ROs). As for NR Rel-15, preamble partitioning is already supported for group A and group B (early indication of the amount of data the UE has to transmit), and in Rel-16, Msg1 separation was introduced to distinguish 4-step RACH and 2-step RACH procedures. As such, improved systems and methods for early indication of features are needed.

### SUMMARY

Systems and methods for early indication for multiple features are provided. In some embodiments, a method performed by a wireless device for early indication of features includes: determining to use an on-demand Random Access (RA) resource; transmitting, to a network node, an activation preamble to activate the on-demand RA resource; and transmitting, to the network node, a preamble on the on-demand RA resource.

Certain embodiments may provide one or more of the following technical advantages. The amount of RA resources can be made larger when there is demand for it. If no User Equipment (UE) is interested in using the on-demand RA resource, those radio resources can be used by the network for other purposes, e.g., dynamic scheduling of user data on Physical Uplink Shared Channel (PUSCH). The amount of RA resources hence scales with the demand without tying up and wasting resources when not used.

Certain aspects of the present disclosure and their embodiments may provide solutions to the aforementioned or other challenges. In some embodiments disclosed herein, there are two levels of RA resources, a first level and a second level. In some embodiments, the second level is referred to as on-demand RA resource. In some embodiments, the on-demand RA resource is by default not active/available. The on-demand RA resource becomes active if (one or more) UEs send a so called “activation preamble” using the first level of RA resources. If a UE wants to use the on-demand RA resources, it should first send the activation preamble upon which the on-demand RA resources become active and the UE can send a preamble in the on-demand RA resource. The network correspondingly will monitor for the activation preamble and upon reception of this preamble, the network would enable and start monitoring for preamble transmissions in the on-demand RA resources.

On-demand RA resources to enable further Msg1 early indication (e.g., preamble partitioning or separate RACH occasions) for new features, and any combinations of features requiring early Msg1 indication.

There are, proposed herein, various embodiments which address one or more of the issues disclosed herein. In some embodiments, a method performed by a wireless device for early indication of features includes one or more of: determining to use an on-demand RA resource; transmitting, to a network node, an activation preamble to activate the on-demand RA resource; and transmitting, to the network node, a preamble on the on-demand RA resource.

In some embodiments, the on-demand RA resource enables further Msg1 early indication.

In some embodiments, the further Msg1 early indication comprises one or more of the group consisting of: Coverage Enhancement (CE) Reduced Capability (RedCap) NR devices Small Data Transmission (SDT), slicing, and Non-Terrestrial Networks (NTN).

In some embodiments, transmitting the activation preamble comprises transmitting using preamble partitioning. In some embodiments, transmitting the activation preamble comprises transmitting using a separate Random Access Channel (RACH) occasions.

In some embodiments, transmitting the preamble on the on-demand RA resource activates a third level of RA resource; and the method further comprises: transmitting, to the network node, a preamble on the third level of RA resource.

In some embodiments, a method performed by a base station for early indication 25 of features, the method comprising one or more of: receiving, from a wireless device, an activation preamble to activate an on-demand RA resource; activating the on-demand RA resource; and receiving, from the wireless device, a preamble on the on-demand RA resource.

In some embodiments, the on-demand RA resource enables further Msg1 early indication. In some embodiments, the further Msg1 early indication comprises one or more of the group consisting of: CE, RedCap NR devices, SDT slicing, and NTN.

In some embodiments, receiving the activation preamble comprises receiving using preamble partitioning. In some embodiments, receiving the activation preamble comprises receiving using a separate RACH occasions.

In some embodiments, receiving the preamble on the on-demand RA resource activates a third level of RA resource; and the method further comprises one or more of: activating the third level of RA resource; and receiving, from the wireless device, a preamble on the third level of RA resource.

In some embodiments, if no activation preamble is received, at least a part of the radio resources for the on-demand RA resource are used for other purposes. In some embodiments, the other purposes includes: dynamic scheduling of user data.

In some embodiments, the method also includes, in response to receiving the activation preamble, scheduling a Msg2 reply.

In some embodiments, the method also includes: estimating a number of wireless devices are requesting the on-demand RA resource; and tuning the size of the on-demand RA resource based on the estimated number of wireless devices are requesting the on-demand RA resource.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a 4-step Random Access Channel (RACH) procedure;

FIG. 2 illustrates a 2-step Random Access (RA) procedure;

FIG. 3 illustrates one example of a cellular communications system in which embodiments of the present disclosure may be implemented;

FIG. 4 illustrates a method performed by a wireless device for early indication of features, according to some embodiments of the present disclosure;

FIG. 5 illustrates a method performed by a base station for early indication of features, according to some embodiments of the present disclosure;

FIG. 6 illustrates a RACH Occasion structure with four activation preambles associated with existing preamble partitions (two Synchronization Signal Blocks (SSBs) and two groups, Contention-Free Preambles (CFPR) ignored because do not require on-demand PRACH), according to some embodiments of the present disclosure;

FIG. 7 illustrates an example of UEs requesting mixed services and dynamically scheduled on-demand PRACH slots, according to some embodiments of the present disclosure;

FIG. 8 is a schematic block diagram of a radio access node according to some embodiments of the present disclosure;

FIG. 9 is a schematic block diagram that illustrates a virtualized embodiment of the radio access node according to some embodiments of the present disclosure;

FIG. 10 is a schematic block diagram of the radio access node according to some other embodiments of the present disclosure;

FIGS. 11 and 12 are schematic block diagrams of a wireless communication device, according to some embodiments of the present disclosure;

FIG. 13 illustrates a communication system including a telecommunication network, such as a Third Generation Partnership Project (3GPP)-type cellular network, which comprises an access network, such as a Radio Access Network (RAN), and a core network, according to some other embodiments of the present disclosure;

FIG. 14 illustrates a communication system, a host computer comprises hardware including a communication interface configured to set up and maintain a wired or wireless connection with an interface of a different communication device of the communication system, according to some other embodiments of the present disclosure;

FIGS. 15-18 are flowcharts illustrating a method implemented in a communication system, according to some other embodiments of the present disclosure.

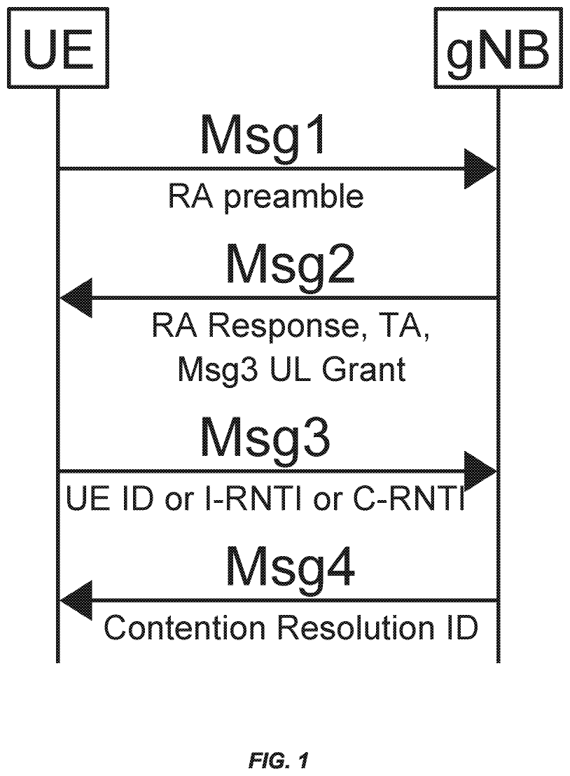

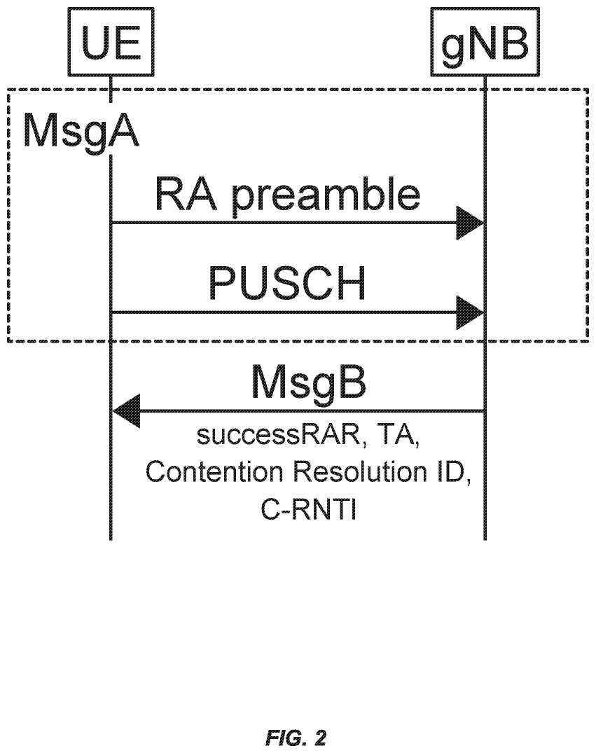

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include but are not limited to: a User Equipment device (UE) in a 3GPP network, a Machine Type Communication (MTC) device, and an Internet of Things (IOT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

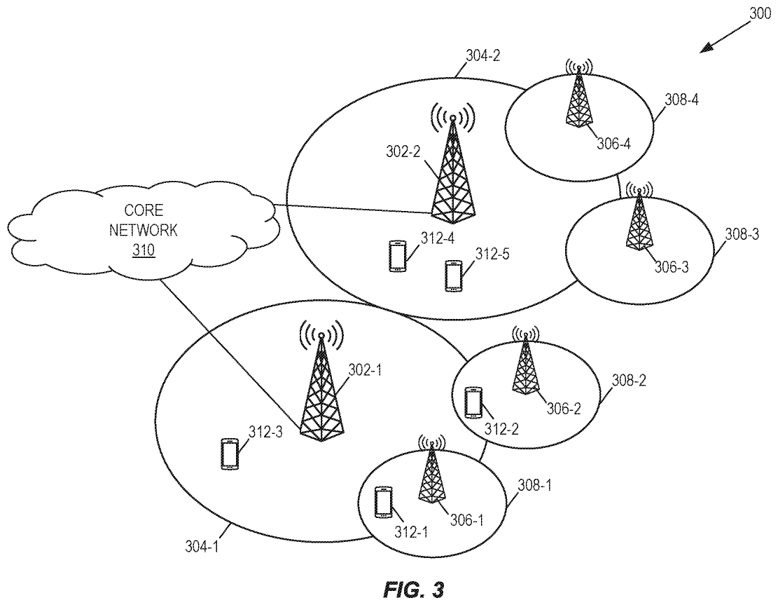

FIG. 3 illustrates one example of a cellular communications system 300 in which embodiments of the present disclosure may be implemented. In the embodiments described herein, the cellular communications system 300 is a 5G system (5GS) including a Next Generation RAN (NG-RAN) and a 5G Core (5GC). In this example, the RAN includes base stations 302-1 and 302-2, which in the 5GS include NR base stations (gNBs) and optionally next generation eNBs (ng-eNBs) (e.g., LTE RAN nodes connected to the 5GC), controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or RRHs, or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5G System (5GS) is referred to as the 5GC. The base stations 302 (and optionally the low power nodes 306) are connected to the core network 310.

The base stations 302 and the low power nodes 306 provide service to wireless communication devices 312-1 through 312-5 in the corresponding cells 304 and 308. The wireless communication devices 312-1 through 312-5 are generally referred to herein collectively as wireless communication devices 312 and individually as wireless communication device 312. In the following description, the wireless communication devices 312 are oftentimes UEs, but the present disclosure is not limited thereto.

As a general assumption in the system there are a number of legacy features for which the UE indicates to the network in Msg1. The legacy features are:
Group A vs. Group B
RA-type (4-step vs. 2-step RACH)
SSB index (as many possible values as the number of configured SSB in the cell)

For instance, a specific preamble may be associated with SSB1, 4-step RACH, and Group A, so the network can behave correctly if the preamble has been received (reply in the UE direction and initiate the correct protocol with an appropriate UL Grant for Msg3).

In other words, when a UE selects a random preamble among the legacy ones, it already indicates something regarding the legacy features. Note that the selection of only the RACH Occasion (RO) may indicate something regarding part of the legacy features or may not indicate anything at all.

Another commonly used preamble segment is a Contention-Free Preamble (CFPR). Usually, these preambles are assigned by the network to the UE, so there is no need to duplicate these preambles for other features, as the network knows which set of features will be used by the UE for a given CFPR.

On top of the legacy features, it is assumed that a number of new features are introduced in Rel-17. For the sake of discussion, but not to limit the scope, the features are assumed with potential values: RedCap (binary), Coverage Enhancement (binary), NTN (binary, UE pre-compensation support or not) or Small Data Transmission (SDT, binary) although there might be non-binary features as well, i.e., for slicing where different slices may be indicated.

Note that Msg1 (i.e., message 1) literally means the first message and for random access usually refers to the preamble transmission. In the present disclosure, the UE will send two preambles, first the activation preamble and later another preamble in the on-demand RA resources. While the second preamble is strictly not the first message, it may be referred to as Msg1 in the context of this present disclosure.

It is described herein how a UE sends a particular preamble (referred to as “activation preamble”) to indicate to the network that the UE requests to activate an on-demand RA resource. However, it should be appreciated that instead of an activation preamble, it would be possible to apply the embodiments herein while using some other signal than a RA preamble to indicate to the network that the UE requests to use on-demand RA resources.

As discussed above, in 3GPP, Msg1 indication can be used to indicate the use of a certain feature, either through preamble partitioning or from the use of separately configured RACH Occasions (ROs). As for NR Rel-15, preamble partitioning is already supported for group A and group B (early indication of the amount of data the UE has to transmit), and in Rel-16, Msg1 separation was introduced to distinguish 4-step RACH and 2-step RACH procedures. The problem is that Msg1 indication is being introduced for several Rel-17 features: Coverage Enhancement (CE), reduced capability NR devices (RedCap), Small Data Transmission (SDT), slicing, Non-Terrestrial Networks (NTN), etc. Since there is a maximum of 64 preambles, and many fewer are typically configured in the field, it is not practically possible to further partition the preamble space. Especially since, in general, combinations of features should be supported, and each combination will require yet another partition. Using separate RACH occasions to distinguish the Rel-17 features (and their combinations) in MSG1 may also not be feasible due to additional radio resource overhead and processing that this requires.

Systems and methods for signaling a Pathloss RS are provided. In some embodiments, a method performed by a wireless device for identifying which Transmission and Reception Point (TRP) of a first and a second TRP an update refers to includes: receiving a configuration of a first and a second Sounding Reference Signal (SRS) resource sets, associated to the first and the second TRPs, respectively; receiving a control message indicating a Physical Uplink Shared Channel (PUSCH) pathloss reference update associated to one of the first and the second SRS resource sets; where the control message comprises an indication of which TRP of the plurality of TRPs the pathloss reference update refers to. In some embodiments, the control message comprises a Medium Access Control (MAC) Control Element. In some embodiments, the pathloss reference update comprises a PUSCH Pathloss Reference Signal (RS) ID field. In some embodiments, the pathloss reference update comprises one or more SRS Resource Indicator (SRI) ID fields. In this way, pathloss can be updates for SRIs associated with different SRS resource sets for per TRP power control in PUSCH repetition to multiple TRPs.

### On-Demand RA Resources

In one embodiment, two levels of RA resources exist. One is a first level or resources which are always available and active (e.g., the NR Rel-15/16 RA resources). A second level of resources are available/active only on-demand (e.g., used for early indication for features in Rel-17 or later).

The first level of RA resources will also be referred to as the primary RA resources, and the second level RA resources will also be referred to as on-demand RA resources, for the sake of readability. The term “on-demand preamble” refers to a preamble in an on-demand RA resource.

In the first level of RA resources, there is at least one preamble which is used to activate the second level of RA resources. This special preamble (or “preambles” in case there are more than one) will herein, for the sake of readability, be referred to as an activation preamble. In the example above, the network will interpret the reception of an activation preamble as if there is at least one UE interested in using on-demand RA resources, for example, to be able to indicate early indication for a Rel-17 (or later) feature, or combination thereof. Note that the preamble receiver is a matching filter which only detects if the energy of a specific preamble sequence is above a certain threshold, i.e., there will be no collision if two or more UE transmit the same activation preamble and the networks action will be the same. Related to this, there is in general no need to configure more than one activation preamble in the primary RA resources for UEs to indicate their need for on-demand RA resources (apart from the joint early indication with pre Rel-17 features as outlined in 6.1.2 below). Note that in case multiple activation preambles are defined, they should correspond to a specific set of on-demand preambles separate from the ones corresponding to another activation preamble. This set can be a whole distinct on-demand PRACH slot, a RO in an on-demand PRACH slot, or a specific partition in the on-demand PRACH slot.

A UE which intends to perform a RA procedure using a preamble in one of the on-demand RA resource shall first send the corresponding activation preamble.

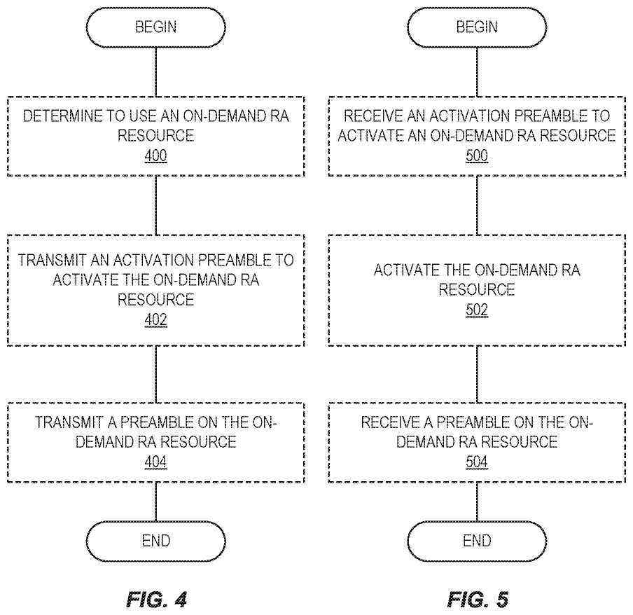

FIG. 4 illustrates a method performed by a wireless device for early indication of features, according to some embodiments of the present disclosure. In some embodiments, the wireless device optionally performs one or more of: determining to use an on-demand RA resource (step 400); transmitting, to a network node, an activation preamble to activate the on-demand RA resource (step 402); and transmitting, to the network node, a preamble on the on-demand RA resource (step 404).

FIG. 5 illustrates a method optionally performed by a base station for early indication of features, according to some embodiments of the present disclosure. In some embodiments, the base station performs one or more of: receiving, from a wireless device, an activation preamble to activate an on-demand RA resource (step 500); activating the on-demand RA resource (step 502); and receiving, from the wireless device, a preamble on the on-demand RA resource (step 504).

### Activation Preamble Per Group of Preambles in Primary RA Resources

As described above, according to current 3GPP specifications, the RA resources can be divided up in several sub-groups; one group for 2-step RA and another group for 4-step RA, one group for preamble group A and another group for preamble group B, etc. In one embodiment of this present disclosure, there is one activation preamble per preamble sub-group in the primary RA resources. I.e., any of the legacy features (pre Rel-17) which require early Msg1 indication can in this way be combined with early Msg1 indication for any new features (Rel-17 or later). In an alternative embodiment, only one activation preamble in total is used, and any combined support or legacy features (pre Rel-17) with new features (Rel-17 or later) must then be indicated using the on-demand RA resources.

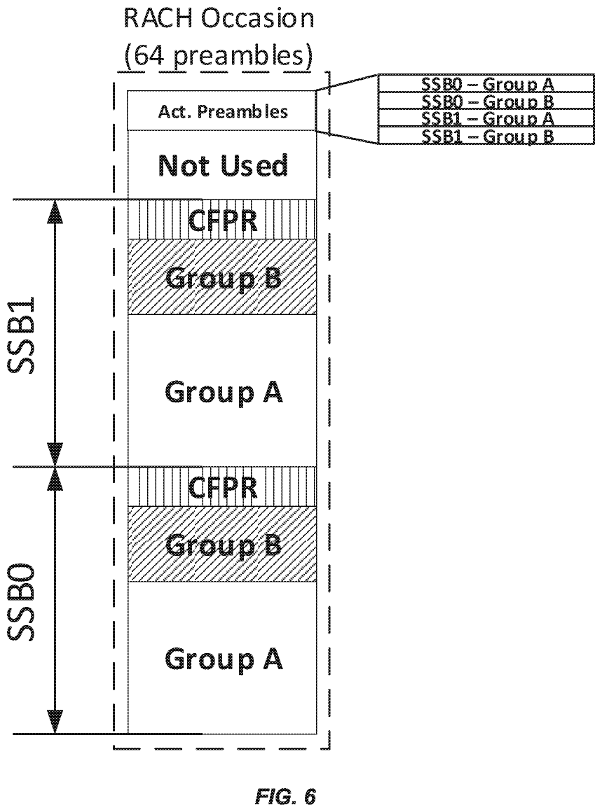

For example, for each of the existing groups of preambles there is an associated activation preamble used to request an on-demand PRACH. For instance, one activation preamble is associated to the set of preambles that indicates SSB1, 4-step RA and GroupA. The activation preambles may be contiguous to the set of preambles they are associated with, or they might be located in a special region of the not used preambles in each RO. FIG. 6 shows an example of the latter case. FIG. 6 illustrates a RACH Occasion structure with four activation preambles associated with existing preamble partitions (two SSBs and two groups, CFPR ignored because they do not require on-demand PRACH), according to some embodiments of the present disclosure.

### Network Behavior

When the gNB detects one of the activation preambles has been transmitted, it knows that one (or more) UE is requesting to enable the second level RA resources, i.e., the on-demand RA resources. Therefore, it will activate the second level RA resources and monitor for transmissions on those resources.

The configuration of the on-demand RA resources can be configured in system information, but the gNB can use the associated radio resources for other transmissions unless any UE has requested an on-demand RA resource (e.g., dynamically scheduled Physical Uplink Shared Channel (PUSCH)). This is beneficial since the on-demand RA resources are not going to consume resources unless they are needed.

The above solution assumes legacy preamble partitioning for the new activation preambles. However, in one embodiment of the present disclosure, legacy UEs can still use the activation preambles configured in the primary RA resources. That is, which of the existing preambles are activation preambles is not clear to legacy UEs (e.g., configured in an extension which is ignored by a Rel-15 UEs but read by a Rel-17 UE). In this case, when an activation preamble is detected, gNB must both schedule a Msg2 reply (in case of legacy UE which in unaware) and activate the on-demand RA resources (in case of a UE intending to include early Msg1 indication as outline above).

### Mapping of Features to On-Demand RA Resources

The structure of the on-demand RA resources is similar to the legacy RA resources, but the preambles may, for example, be divided so that they represent only certain combinations of features. Following the non-limiting example, there might be three regions of the RA resources representing RedCap enabled and SDT disabled, RedCap disabled and SDT enabled, or both features enabled (both features disabled is the default setting for which the UE does not need to request an on-demand PRACH). When the UE transmits the second preamble in the appropriate region, the gNB has a complete view of the requested features and so it provides the appropriate service.

In an alternative embodiment, the on-demand PRACH has also a preamble subdivision based on the SSB index, similar to the legacy PRACH. Due to radio propagation issues, it might be necessary for the gNB to steer the receiving beam (e.g., through analog beamforming) in the correct direction in order to detect correctly the second preamble in the on-demand PRACH.

In an alternative embodiment, the on-demand PRACH (or PRACHs) is not configured in SI but is allocated dynamically by the gNB that transmits a Msg2 after the reception of the first activation preamble. This Msg2 carries a UL Grant that indicates to the UE(s) when and where the on-demand PRACH slot will occur and optionally how the preambles are partitioned for the different early indication of features or combination therefore (alt. this last part is still in SI). Since the on-demand PRACH is scheduled dynamically, the association between first and second preamble is maintained.

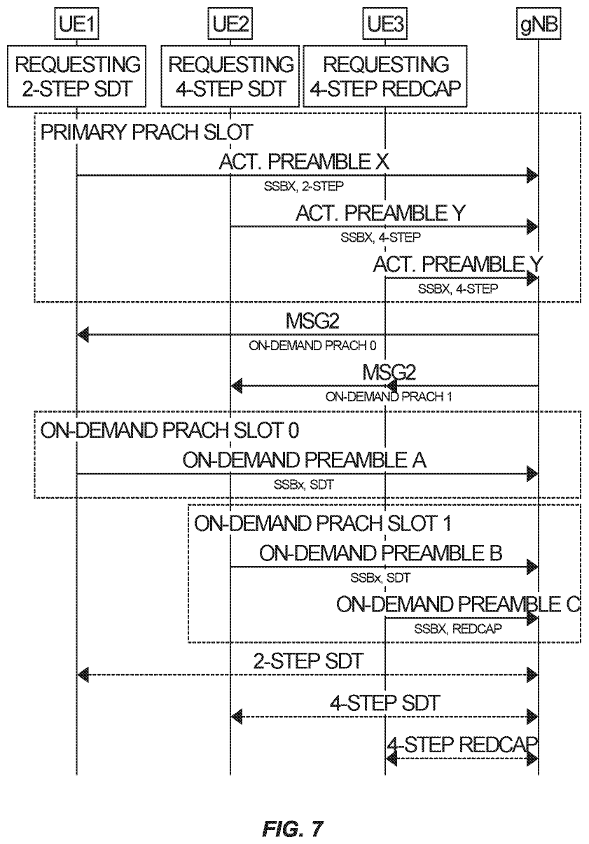

FIG. 7 shows a protocol diagram where three UEs are requesting mixed services and considering this last embodiment. FIG. 7 illustrates an example of UEs requesting mixed services and dynamically scheduled on-demand PRACH slots, according to some embodiments of the present disclosure.

### On-Demand RA Resources Size Dependent on Number of Activation Preambles

In an alternative embodiment, there is more than one activation preamble associated with a certain combination of legacy features. In this way, the gNB can estimate how many UEs are requesting the on-demand PRACH in order to tune it, size it, and optimize the resource consumption. For example, if there are five activation preambles and the network receives only one of these five, the network may provide fewer on-demand RA resources compared to if the network receives all five preambles. The motivation for this is that the number of activated preambles is linked to the number of UEs that are requesting the access through a mathematical formula, and so it is possible to estimate one in function of the other. Note: in case two UEs send the same preamble, the network may not be able to distinguish these preamble transmissions, so the above method will only provide an estimate of the number of UEs which request a specific set of on-demand RA resources.

### Multi-Level Generalization

It has been described how there is a first and a second level of RA resources. However, the embodiments of the present disclosure can be generalized to support more than two levels of RA resources. For example, there may be three levels, including a first level which is always active and available. If the UE performs RA using one resource (e.g., a preamble) on the first level of resources, a second level or RA resources becomes available. There may be one part of the second level of RA resources which can be used to activate a third level of RA resources. In this case, if the UE wants to use an RA resource of the third level, it would first send the activation preamble in the first RA resources and then send an activation preamble in the second RA resource to finally be able to perform RA using the third level RA resource.

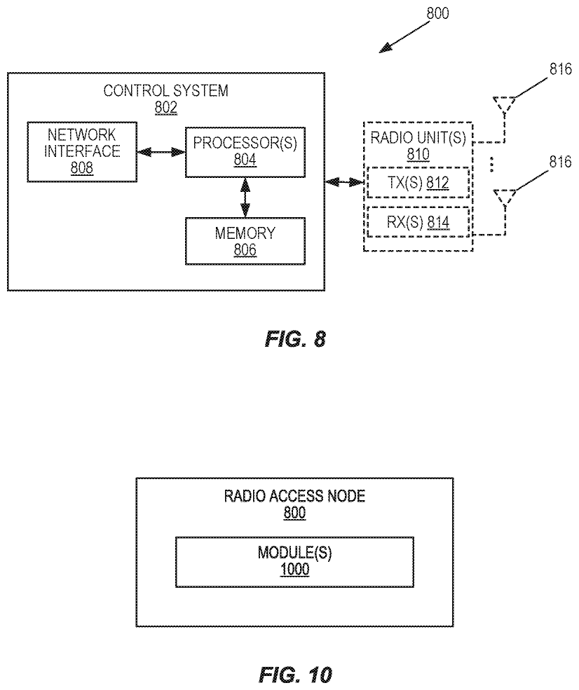

FIG. 8 is a schematic block diagram of a radio access node 800 according to some embodiments of the present disclosure. Optional features are represented by dashed boxes. The radio access node 800 may be, for example, a base station 302 or 306 or a network node that implements all or part of the functionality of the base station 302 or gNB described herein. As illustrated, the radio access node 800 includes a control system 802 that includes one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. In addition, the radio access node 800 may include one or more radio units 810 that each includes one or more transmitters 812 and one or more receivers 814 coupled to one or more antennas 816. The radio units 810 may be referred to or be part of radio interface circuitry. In some embodiments, the radio unit(s) 810 is external to the control system 802 and connected to the control system 802 via, e.g., a wired connection (e.g., an optical cable). However, in some other embodiments, the radio unit(s) 810 and potentially the antenna(s) 816 are integrated together with the control system 802. The one or more processors 804 operate to provide one or more functions of a radio access node 800 as described herein. In some embodiments, the function(s) are implemented in software that is stored, e.g., in the memory 806 and executed by the one or more processors 804.

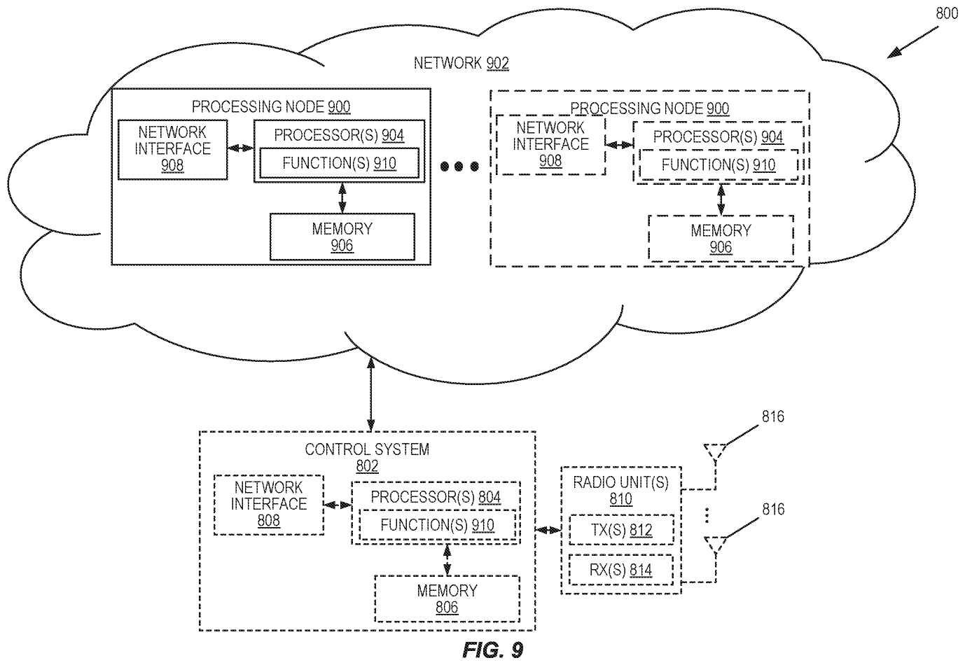

FIG. 9 is a schematic block diagram that illustrates a virtualized embodiment of the radio access node 800 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 800 in which at least a portion of the functionality of the radio access node 800 is implemented as a virtual component(s) (e.g., via a virtual machine(s) executing on a physical processing node(s) in a network(s)). As illustrated, in this example, the radio access node 800 may include the control system 802 and/or the one or more radio units 810, as described above. The control system 802 may be connected to the radio unit(s) 810 via, for example, an optical cable or the like. The radio access node 800 includes one or more processing nodes 900 coupled to or included as part of a network(s) 902. If present, the control system 802 or the radio unit(s) are connected to the processing node(s) 900 via the network 902. Each processing node 900 includes one or more processors 904 (e.g., CPUs, ASICs, FPGAS, and/or the like), memory 906, and a network interface 908.

In this example, functions 910 of the radio access node 800 described herein are implemented at the one or more processing nodes 900 or distributed across the one or more processing nodes 900 and the control system 802 and/or the radio unit(s) 810 in any desired manner. In some particular embodiments, some or all of the functions 910 of the radio access node 800 described herein are implemented as virtual components executed by one or more virtual machines implemented in a virtual environment(s) hosted by the processing node(s) 900. As will be appreciated by one of ordinary skill in the art, additional signaling or communication between the processing node(s) 900 and the control system 802 is used in order to carry out at least some of the desired functions 910. Notably, in some embodiments, the control system 802 may not be included, in which case the radio unit(s) 810 communicate directly with the processing node(s) 900 via an appropriate network interface(s).

In some embodiments, a computer program including instructions which, when executed by at least one processor, causes the at least one processor to carry out the functionality of radio access node 800 or a node (e.g., a processing node 900) implementing one or more of the functions 910 of the radio access node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the radio access node 800 according to some other embodiments of the present disclosure. The radio access node 800 includes one or more modules 1000, each of which is implemented in software. The module(s) 1000 provide the functionality of the radio access node 800 described herein. This discussion is equally applicable to the processing node 900 of FIG. 9 where the modules 1000 may be implemented at one of the processing nodes 900 or distributed across multiple processing nodes 900 and/or distributed across the processing node(s) 900 and the control system 802.

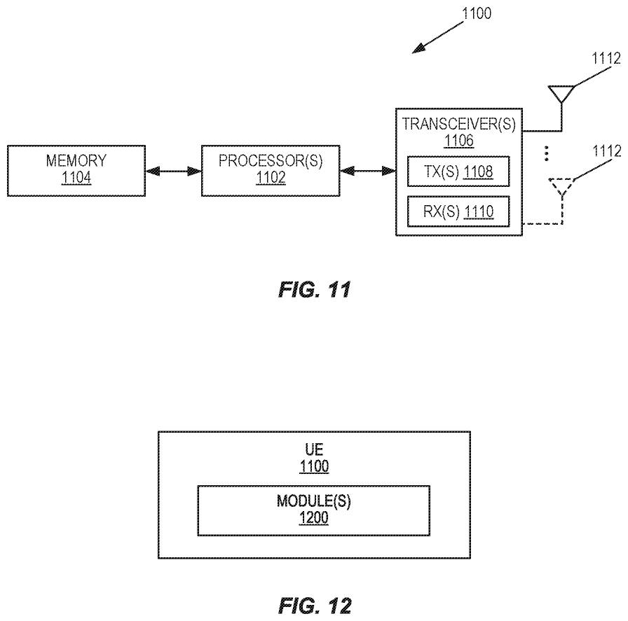

FIG. 11 is a schematic block diagram of a wireless communication device 1100 according to some embodiments of the present disclosure. As illustrated, the wireless communication device 1100 includes one or more processors 1102 (e.g., CPUs, ASICs, FPGAS, and/or the like), memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by on of ordinary skill in the art. The processors 1102 are also referred to herein as processing circuitry. The transceivers 1106 are also referred to herein as radio circuitry. In some embodiments, the functionality of the wireless communication device 1100 described above may be fully or partially implemented in software that is, e.g., stored in the memory 1104 and executed by the processor(s) 1102. Note that the wireless communication device 1100 may include additional components not illustrated in FIG. 11 such as, e.g., one or more user interface components (e.g., an input/output interface including a display, buttons, a touch screen, a microphone, a speaker(s), and/or the like and/or any other components for allowing input of information into the wireless communication device 1100 and/or allowing output of information from the wireless communication device 1100), a power supply (e.g., a battery and associated power circuitry), etc.

In some embodiments, a computer program including instructions which, when executed by at least one processor, causes the at least one processor to carry out the functionality of the wireless communication device 1100 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the wireless communication device 1100 according to some other embodiments of the present disclosure. The wireless communication device 1100 includes one or more modules 1200, each of which is implemented in software. The module(s) 1200 provide the functionality of the wireless communication device 1100 described herein.

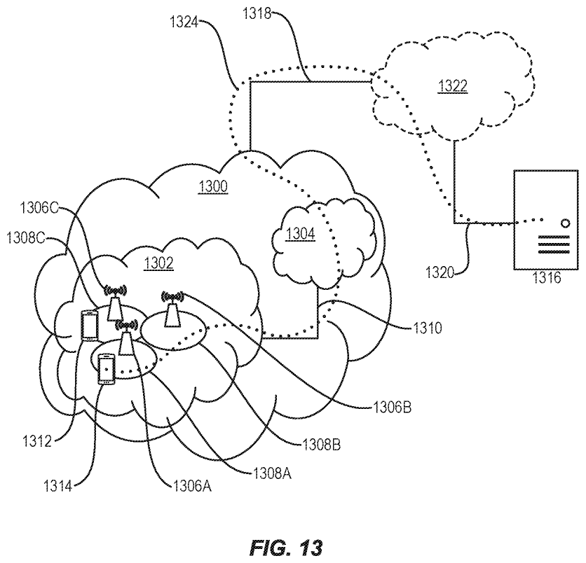

With reference to FIG. 13, in accordance with an embodiment, a communication system includes a telecommunication network 1300, such as a 3GPP-type cellular network, which comprises an access network 1302, such as a RAN, and a core network 1304. The access network 1302 comprises a plurality of base stations 1306A, 1306B, 1306C, such as Node Bs, eNBs, gNBs, or other types of wireless Access Points (APs), each defining a corresponding coverage area 1308A, 1308B, 1308C. Each base station 1306A, 1306B, 1306C is connectable to the core network 1304 over a wired or wireless connection 1310. A first UE 1312 located in coverage area 1308C is configured to wirelessly connect to, or be paged by, the corresponding base station 1306C. A second UE 1314 in coverage area 1308A is wirelessly connectable to the corresponding base station 1306A. While a plurality of UEs 1312, 1314 are illustrated in this example, the disclosed embodiments are equally applicable to a situation where a sole UE is in the coverage area or where a sole UE is connecting to the corresponding base station 1306.

The telecommunication network 1300 is itself connected to a host computer 1316, which may be embodied in the hardware and/or software of a standalone server, a cloud-implemented server, a distributed server, or as processing resources in a server farm. The host computer 1316 may be under the ownership or control of a service provider or may be operated by the service provider or on behalf of the service provider. Connections 1318 and 1320 between the telecommunication network 1300 and the host computer 1316 may extend directly from the core network 1304 to the host computer 1316 or may go via an optional intermediate network 1322. The intermediate network 1322 may be one of, or a combination of more than one of, a public, private, or hosted network; the intermediate network 1322, if any, may be a backbone network or the Internet; in particular, the intermediate network 1322 may comprise two or more sub-networks (not shown).

The communication system of FIG. 13 as a whole enables connectivity between the connected UEs 1312, 1314 and the host computer 1316. The connectivity may be described as an Over-the-Top (OTT) connection 1324. The host computer 1316 and the connected UEs 1312, 1314 are configured to communicate data and/or signaling via the OTT connection 1324, using the access network 1302, the core network 1304, any intermediate network 1322, and possible further infrastructure (not shown) as intermediaries. The OTT connection 1324 may be transparent in the sense that the participating communication devices through which the OTT connection 1324 passes are unaware of routing of uplink and downlink communications. For example, the base station 1306 may not or need not be informed about the past routing of an incoming downlink communication with data originating from the host computer 1316 to be forwarded (e.g., handed over) to a connected UE 1312. Similarly, the base station 1306 need not be aware of the future routing of an outgoing uplink communication originating from the UE 1312 towards the host computer 1316.

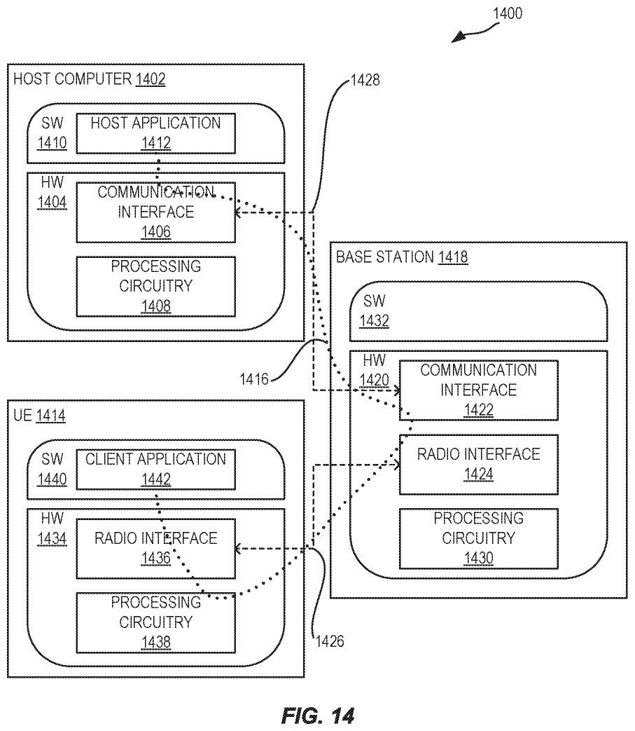

Example implementations, in accordance with an embodiment, of the UE, base station, and host computer discussed in the preceding paragraphs will now be described with reference to FIG. 14. In a communication system 1400, a host computer 1402 comprises hardware 1404 including a communication interface 1406 configured to set up and maintain a wired or wireless connection with an interface of a different communication device of the communication system 1400. The host computer 1402 further comprises processing circuitry 1408, which may have storage and/or processing capabilities. In particular, the processing circuitry 1408 may comprise one or more programmable processors, ASICs, FPGAs, or combinations of these (not shown) adapted to execute instructions. The host computer 1402 further comprises software 1410, which is stored in or accessible by the host computer 1402 and executable by the processing circuitry 1408. The software 1410 includes a host application 1412. The host application 1412 may be operable to provide a service to a remote user, such as a UE 1414 connecting via an OTT connection 1416 terminating at the UE 1414 and the host computer 1402. In providing the service to the remote user, the host application 1412 may provide user data which is transmitted using the OTT connection 1416.

The communication system 1400 further includes a base station 1418 provided in a telecommunication system and comprising hardware 1420 enabling it to communicate with the host computer 1402 and with the UE 1414. The hardware 1420 may include a communication interface 1422 for setting up and maintaining a wired or wireless connection with an interface of a different communication device of the communication system 1400, as well as a radio interface 1424 for setting up and maintaining at least a wireless connection 1426 with the UE 1414 located in a coverage area (not shown in FIG. 14) served by the base station 1418. The communication interface 1422 may be configured to facilitate a connection 1428 to the host computer 1402. The connection 1428 may be direct or it may pass through a core network (not shown in FIG. 14) of the telecommunication system and/or through one or more intermediate networks outside the telecommunication system. In the embodiment shown, the hardware 1420 of the base station 1418 further includes processing circuitry 1430, which may comprise one or more programmable processors, ASICs, FPGAs, or combinations of these (not shown) adapted to execute instructions. The base station 1418 further has software 1432 stored internally or accessible via an external connection.

The communication system 1400 further includes the UE 1414 already referred to. The UE's 1414 hardware 1434 may include a radio interface 1436 configured to set up and maintain a wireless connection 1426 with a base station serving a coverage area in which the UE 1414 is currently located. The hardware 1434 of the UE 1414 further includes processing circuitry 1438, which may comprise one or more programmable processors, ASICS, FPGAs, or combinations of these (not shown) adapted to execute instructions. The UE 1414 further comprises software 1440, which is stored in or accessible by the UE 1414 and executable by the processing circuitry 1438. The software 1440 includes a client application 1442. The client application 1442 may be operable to provide a service to a human or non-human user via the UE 1414, with the support of the host computer 1402. In the host computer 1402, the executing host application 1412 may communicate with the executing client application 1442 via the OTT connection 1416 terminating at the UE 1414 and the host computer 1402. In providing the service to the user, the client application 1442 may receive request data from the host application 1412 and provide user data in response to the request data. The OTT connection 1416 may transfer both the request data and the user data. The client application 1442 may interact with the user to generate the user data that it provides.

It is noted that the host computer 1402, the base station 1418, and the UE 1414 illustrated in FIG. 14 may be similar or identical to the host computer 1316, one of the base stations 1306A, 1306B, 1306C, and one of the UEs 1312, 1314 of FIG. 13, respectively. This is to say, the inner workings of these entities may be as shown in FIG. 14 and independently, the surrounding network topology may be that of FIG. 13.

In FIG. 14, the OTT connection 1416 has been drawn abstractly to illustrate the communication between the host computer 1402 and the UE 1414 via the base station 1418 without explicit reference to any intermediary devices and the precise routing of messages via these devices. The network infrastructure may determine the routing, which may be configured to hide from the UE 1414 or from the service provider operating the host computer 1402, or both. While the OTT connection 1416 is active, the network infrastructure may further take decisions by which it dynamically changes the routing (e.g., on the basis of load balancing consideration or reconfiguration of the network).

The wireless connection 1426 between the UE 1414 and the base station 1418 is in accordance with the teachings of the embodiments described throughout this disclosure. One or more of the various embodiments improve the performance of OTT services provided to the UE 1414 using the OTT connection 1416, in which the wireless connection 1426 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime, etc.

A measurement procedure may be provided for the purpose of monitoring data rate, latency, and other factors on which the one or more embodiments improve. There may further be an optional network functionality for reconfiguring the OTT connection 1416 between the host computer 1402 and the UE 1414, in response to variations in the measurement results. The measurement procedure and/or the network functionality for reconfiguring the OTT connection 1416 may be implemented in the software 1410 and the hardware 1404 of the host computer 1402 or in the software 1440 and the hardware 1434 of the UE 1414, or both. In some embodiments, sensors (not shown) may be deployed in or in association with communication devices through which the OTT connection 1416 passes; the sensors may participate in the measurement procedure by supplying values of the monitored quantities exemplified above, or supplying values of other physical quantities from which the software 1410, 1440 may compute or estimate the monitored quantities. The reconfiguring of the OTT connection 1416 may include message format, retransmission settings, preferred routing, etc.; the reconfiguring need not affect the base station 1418, and it may be unknown or imperceptible to the base station 1418. Such procedures and functionalities may be known and practiced in the art. In certain embodiments, measurements may involve proprietary UE signaling facilitating the host computer 1402's measurements of throughput, propagation times, latency, and the like. The measurements may be implemented in that the software 1410 and 1440 causes messages to be transmitted, in particular empty or ‘dummy’ messages, using the OTT connection 1416 while it monitors propagation times, errors, etc.

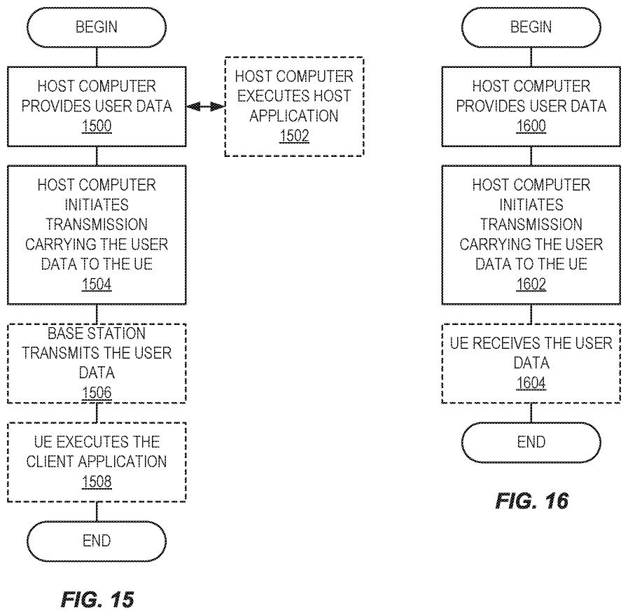

FIG. 15 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 15 will be included in this section. In step 1500, the host computer provides user data. In sub-step 1502 (which may be optional) of step 1500, the host computer provides the user data by executing a host application. In step 1504, the host computer initiates a transmission carrying the user data to the UE. In step 1506 (which may be optional), the base station transmits to the UE the user data which was carried in the transmission that the host computer initiated, in accordance with the teachings of the embodiments described throughout this disclosure. In step 1508 (which may also be optional), the UE executes a client application associated with the host application executed by the host computer.

FIG. 16 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 16 will be included in this section. In step 1600 of the method, the host computer provides user data. In an optional sub-step (not shown) the host computer provides the user data by executing a host application. In step 1602, the host computer initiates a transmission carrying the user data to the UE. The transmission may pass via the base station, in accordance with the teachings of the embodiments described throughout this disclosure. In step 1604 (which may be optional), the UE receives the user data carried in the transmission.

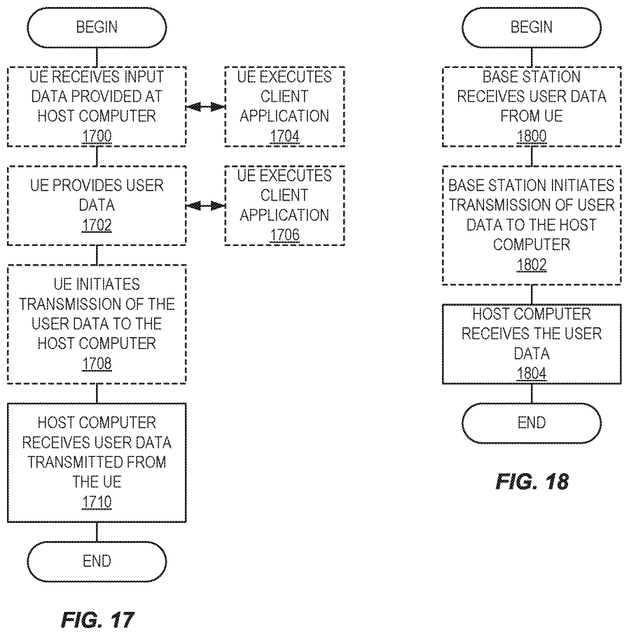

FIG. 17 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 17 will be included in this section. In step 1700 (which may be optional), the UE receives input data provided by the host computer. Additionally or alternatively, in step 1702, the UE provides user data. In sub-step 1704 (which may be optional) of step 1700, the UE provides the user data by executing a client application. In sub-step 1706 (which may be optional) of step 1702, the UE executes a client application which provides the user data in reaction to the received input data provided by the host computer. In providing the user data, the executed client application may further consider user input received from the user. Regardless of the specific manner in which the user data was provided, the UE initiates, in sub-step 1708 (which may be optional), transmission of the user data to the host computer. In step 1710 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station, and a UE which may be those described with reference to FIGS. 13 and 14. For simplicity of the present disclosure, only drawing references to FIG. 18 will be included in this section. In step 1800 (which may be optional), in accordance with the teachings of the embodiments described throughout this disclosure, the base station receives user data from the UE. In step 1802 (which may be optional), the base station initiates transmission of the received user data to the host computer. In step 1804 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### EMBODIMENTS

### Group A Embodiments

Embodiment 1: A method performed by a wireless device for early indication of features, the method comprising one or more of: determining (400) to use an on-demand RA resource; transmitting (402), to a network node, an activation preamble to activate the on-demand RA resource; and transmitting (404), to the network node, a preamble on the on-demand RA resource.
Embodiment 2: The method of embodiment 1 wherein the on-demand RA resource enables further Msg1 early indication.
Embodiment 3: The method of embodiment 2 wherein the further Msg1 early indication comprises one or more of the group consisting of: Coverage Enhancement, CE, reduced capability, RedCap, NR devices, Small Data Transmission, SDT, slicing, and Non-Terrestrial Networks, NTN.
Embodiment 4: The method of any of embodiments 1 to 3 wherein transmitting the activation preamble comprises transmitting using preamble partitioning.
Embodiment 5: The method of any of embodiments 1 to 4 wherein transmitting the activation preamble comprises transmitting using a separate Random Access Channel, RACH, occasions.
Embodiment 6: The method of any of embodiments 1 to 5 wherein transmitting the preamble on the on-demand RA resource activates a third level of RA resource; and the method further comprising: transmitting, to the network node, a preamble on the third level of RA resource.
Embodiment 7: The method of any of the previous embodiments, further comprising: providing user data; and forwarding the user data to a host computer via the transmission to the base station.

### Group B Embodiments

Embodiment 8: A method performed by a base station for early indication of features, the method comprising one or more of: receiving (500), from a wireless device, an activation preamble to activate an on-demand RA resource; activating (502) the on-demand RA resource; and receiving (504), from the wireless device, a preamble on the on-demand RA resource.
Embodiment 9: The method of embodiment 8 wherein the on-demand RA resource enables further Msg1 early indication.
Embodiment 10: The method of embodiment 9 wherein the further Msg1 early indication comprises one or more of the group consisting of: Coverage Enhancement, CE, reduced capability, RedCap, NR devices, Small Data Transmission, SDT, slicing, and Non-Terrestrial Networks, NTN.
Embodiment 11: The method of any of embodiments 8 to 10 wherein receiving the activation preamble comprises receiving using preamble partitioning.
Embodiment 12: The method of any of embodiments 8 to 11 wherein receiving the activation preamble comprises receiving using a separate Random Access Channel, RACH, occasions.
Embodiment 13: The method of any of embodiments 8 to 12 wherein receiving the preamble on the on-demand RA resource activates a third level of RA resource; and the method further comprising one or more of: activating the third level of RA resource; and receiving, from the wireless device, a preamble on the third level of RA resource.
Embodiment 14: The method of any of embodiments 8 to 13 wherein, if no activation preamble is received, at least a part of the radio resources for the on-demand RA resource are used for other purposes.
Embodiment 15: The method of embodiment 14 wherein the other purposes comprises: dynamic scheduling of user data.
Embodiment 16: The method of any of embodiments 8 to 15 further comprising: in response to receiving the activation preamble, scheduling a Msg2 reply.
Embodiment 17: The method of any of embodiments 8 to 16 further comprising: estimating a number of wireless devices are requesting the on-demand RA resource; and tuning the size of the on-demand RA resource based on the estimated number of wireless devices are requesting the on-demand RA resource.
Embodiment 18: The method of any of the previous embodiments, further comprising: obtaining user data; and forwarding the user data to a host computer or a wireless device.

### Group C Embodiments

Embodiment 19: A wireless device for early indication of features, the wireless device comprising: processing circuitry configured to perform any of the steps of any of the Group A embodiments; and power supply circuitry configured to supply power to the wireless device.
Embodiment 20: A base station for early indication of features, the base station comprising: processing circuitry configured to perform any of the steps of any of the Group B embodiments; and power supply circuitry configured to supply power to the base station.
Embodiment 21: A User Equipment, UE, for early indication of features, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.
Embodiment 22: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.
Embodiment 23: The communication system of the previous embodiment further including the base station.
Embodiment 24: The communication system of the previous 2 embodiments, further including the UE, wherein the UE is configured to communicate with the base station.
Embodiment 25: The communication system of the previous 3 embodiments, wherein: the processing circuitry of the host computer is configured to execute a host application, thereby providing the user data; and the UE comprises processing circuitry configured to execute a client application associated with the host application.
Embodiment 26: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.
Embodiment 27: The method of the previous embodiment, further comprising, at the base station, transmitting the user data.
Embodiment 28: The method of the previous 2 embodiments, wherein the user data is provided at the host computer by executing a host application, the method further comprising, at the UE, executing a client application associated with the host application.
Embodiment 29: A User Equipment, UE, configured to communicate with a base station, the UE comprising a radio interface and processing circuitry configured to perform the method of the previous 3 embodiments.
Embodiment 30: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.
Embodiment 31: The communication system of the previous embodiment, wherein the cellular network further includes a base station configured to communicate with the UE.
Embodiment 32: The communication system of the previous 2 embodiments, wherein: the processing circuitry of the host computer is configured to execute a host application, thereby providing the user data; and the UE's processing circuitry is configured to execute a client application associated with the host application.
Embodiment 33: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.
Embodiment 34: The method of the previous embodiment, further comprising at the UE, receiving the user data from the base station.
Embodiment 35: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.
Embodiment 36: The communication system of the previous embodiment, further including the UE.
Embodiment 37: The communication system of the previous 2 embodiments, further including the base station, wherein the base station comprises a radio interface configured to communicate with the UE and a communication interface configured to forward to the host computer the user data carried by a transmission from the UE to the base station.
Embodiment 38: The communication system of the previous 3 embodiments, wherein: the processing circuitry of the host computer is configured to execute a host application; and the UE's processing circuitry is configured to execute a client application associated with the host application, thereby providing the user data.
Embodiment 39: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.
Embodiment 40: A method implemented in a communication system including a host computer, a base station, and a User Equipment, UE, the method comprising: at the host computer, receiving user data transmitted to the base station from the UE, wherein the UE performs any of the steps of any of the Group A embodiments.
Embodiment 41: The method of the previous embodiment, further comprising, at the UE, providing the user data to the base station.
Embodiment 42: The method of the previous 2 embodiments, further comprising: at the UE, executing a client application, thereby providing the user data to be transmitted; and at the host computer, executing a host application associated with the client application.
Embodiment 43: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.
Embodiment 44: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.
Embodiment 45: The communication system of the previous embodiment further including the base station.
Embodiment 46: The communication system of the previous 2 embodiments, further including the UE, wherein the UE is configured to communicate with the base station.
Embodiment 47: The communication system of the previous 3 embodiments, wherein: the processing circuitry of the host computer is configured to execute a host application; and the UE is configured to execute a client application associated with the host application, thereby providing the user data to be received by the host computer.
Embodiment 48: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.
Embodiment 49: The method of the previous embodiment, further comprising at the base station, receiving the user data from the UE.
Embodiment 50: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CE Coverage Enhancement
CFPR Contention-Free Preamble
CPU Central Processing Unit
CR-ID Contention Resolution ID
C-RNTI Cell Radio Network Temporary Identifier
DCI Downlink Control Information
DN Data Network
DSP Digital Signal Processor
eNB Enhanced or Evolved Node B
FPGA
Field Programmable Gate Array
New Radio Base Station
gNB
gNB-CU New Radio Base Station Central Unit
gNB-DU New Radio Base Station Distributed Unit
HARQ Hybrid Automatic Repeat Request
HSS Home Subscriber Server
IOT Internet of Things
I-RNTI Inactive-Radio Network Temporary Identifier
IP
Internet Protocol
Long Term Evolution
LTE
MME Mobility Management Entity
MTC Machine Type Communication
NEF Network Exposure Function
NF Network Function
NR New Radio
NRF Network Function Repository Function
NSSF Network Slice Selection Function
NTN Non-Terrestrial Network
OTT Over-the-Top
PBCH Physical Broadcast Channel
PC Personal Computer
PCF
Policy Control Function
Physical Downlink Control Channel
PDCCH
P-GW Packet Data Network Gateway
PRACH Physical Random Access Channel
PUSCH Physical Uplink Shared Channel
RA Random Access
RACH Random Access Channel
RAM Random Access Memory
RAN Radio Access Network
RAR Random Access Response
RedCap Reduced Capability
RNTI Radio Network Temporary Identifier
RO RACH Occasions
ROM Read Only Memory
RRC Radio Resource Control
RRH Remote Radio Head
RS Reference Signal
RTT Round Trip Time
SCEF Service Capability Exposure Function
SDT Small Data Transmission
SMF Session Management Function
SRI Sounding Reference Signal Resource Indicator
SRS
Sounding Reference Signal
Synchronization Signal
SS
SSB Synchronization Signal Block
TA Timing Advance
TC Temporary Cell
TC-RNTI Temporary Cell Radio Network Temporary Identifier
Temporary Mobile Subscriber Identity TMSI
UDM Unified Data Management
UE User Equipment
UL Uplink
UPF User Plane Function

Those skilled in the art will recognize improvements and modifications to the embodiments of the present disclosure. All such improvements and modifications are considered within the scope of the concepts disclosed herein.

1. A method performed by a wireless device for early indication of features, the method comprising:
determining to use an on-demand Random Access, RA, resource;
transmitting, to a network node, an activation preamble to activate the on-demand RA resource; and
transmitting, to the network node, a preamble on the on-demand RA resource.

2. The method of claim 1 wherein there are two levels of RA resources, a first level and a second level, the on-demand RA resource comprises the second level RA resources.

3. The method of claim 2 wherein the further Msg1 early indication comprises one or more of the group consisting of: Coverage Enhancement, CE, reduced capability, RedCap, New Radio, NR, devices, Small Data Transmission, SDT, slicing, and Non-Terrestrial Networks, NTN.

4. The method of claim 1, wherein transmitting the activation preamble comprises transmitting using preamble partitioning.

5. The method of claim 1, wherein transmitting the activation preamble comprises transmitting using a separate Random Access Channel, RACH, occasion.

6. The method of claim 1, wherein transmitting the preamble on the on-demand RA resource activates a third level of RA resource; and the method further comprises: transmitting, to the network node, a preamble on the third level of RA resource.

7. The method of claim 1, wherein the wireless device operates in a Fifth Generation, 5G, NR network.

8-17. (canceled)

18. A wireless device for early indication of features, the wireless device comprising one or more processors configured to cause the wireless device to:
determine to use an on-demand Random Access, RA, resource;
transmit, to a network node, an activation preamble to activate the on-demand RA resource; and
transmit, to the network node, a preamble on the on-demand RA resource.

19-21. (canceled)
